(19) United States
(12) Patent Application Publication
(10) Pub. No.: US 2024/0202678 A1
(43) Pub. Date: Jun. 20, 2024

(54) A CRYPTOCURRENCY-BASED AND COMPUTER-IMPLEMENTED TRANSACTION METHOD FOR ONLINE SERVICES AND AN ASSOCIATED NETWORK-COMPATIBLE DEVICE

(71) Applicant: ETO MAGNETIC GmbH, Stockach (DE)

(72) Inventors: Tobias PLÖTZING, Bodman-Ludwigshafen (DE); Benjamin BÖNISCH, Bodman-Ludwigshafen (DE)

(21) Appl. No.: 18/555,051

(22) PCT Filed: Apr. 20, 2021
(86) PCT No.: PCT/EP2021/060238

§ 371 Date: Oct. 12, 2023

(51) Int. Cl. G06Q 20/06; G06Q 20/38

(52) U.S. Cl. CPC G06Q 20/065; G06Q 20/389

(57) ABSTRACT

A computer-implemented transaction method for online services includes at least the steps of: receiving a content provided by a creator by an online service, offering the content by the online service ready for retrieval, in particular at least partially publicly, preferably free of charge, wherein preferably the content is linked by the online service to a creator address, displaying and/or transmitting the content by the online service to a user of the online service, wherein a consumer address is preferably assigned to the user within the online service, computer-based and/or sensor-based registration of a response of the user to the retrieved content, and triggering a direct digital financial transaction between the user and the creator, preferably between the consumer address and the creator address, as a consequence of the computer-based and/or sensor-based registered response of the user to the retrieved content.

### CROSS-REFERENCE TO RELATED APPLICATION

This patent application is a U.S. national stage application of international patent application PCT/EP2021/060238, filed on Apr. 20, 2021, the contents of which are incorporated herein by reference.

### STATE OF THE ART

The invention relates to a computer-implemented transaction method for online services and to a network compatible device.

In very many of today's apps or online services there are Like-functions, commenting-functions etc. With these functions, it is possible for a user to mark a content of another user in such a way that this user receives positive feedback/a compliment. This in turn encourages other users to like the content, since the more likes, the more interesting the content is for many users. In various online services or platforms such as YouTube, Medium, etc., content creators provide content free of charge, for example training videos or tutorials. Many of these users try to earn money through donations and ask for likes or subscriptions to their channels. The operators of the platforms earn money by displaying advertising, some of which is passed on to content creators. The amount passed on often depends on the attractiveness of the content, which can be measured by the number of likes, comments, etc. An alternative on platforms without advertising is for content creators to ask users to donate money by providing online payment service addresses, crypto addresses or account numbers. In fact, many people are willing to make donations for good content to avoid advertising.

From the state-of-the-art numerous cryptocurrencies or the like for numerous applications are known. However, there are only few cryptocurrencies that are free of transaction costs and possess a very high scalability.

The objective of the invention is in particular to provide a method with advantageous characteristics regarding the implementation of online services and/or the accessibility and/or distribution of digital content. A further objective of the invention is in particular to provide an improved usability of content-providing online services. The objective is achieved according to the invention.

### Advantages of the Invention

The invention pertains to a computer-implemented transaction method and/or remuneration method for online services, comprising at least the steps of: receiving a content provided by a creator by an online service, offering the content by the online service ready for retrieval, in particular at least partially publicly, preferably free of charge, wherein preferably the content is linked by the online service to a creator address, displaying and/or transmitting the content by the online service to a user of the online service, wherein a consumer address is preferably assigned to the user within the online service, computer-based and/or sensor-based registration of a response of the user to the retrieved content, and triggering a direct digital financial transaction between the user and the creator, preferably between the consumer address and the creator address, as a consequence of the computer-based and/or sensor-based registered response of the user to the retrieved content. Thus, advantageous characteristics regarding the implementation of online services and/or the accessibility and/or distribution of digital content can advantageously be achieved. Furthermore, an improved usability of content-providing online services can advantageously be achieved. Advantageously, by the proposed method an ad-free content-sharing web community can be advantageously achieved. Preferably, this content-sharing web community can be implemented free from the commercial need for a user data analysis. Thereby, a high data protection and/or a high privacy protection can advantageously be achieved. Moreover, the proposed method advantageously enables the implementation of mostly or even completely decentralized platforms, which preferably are essentially ad-free and essentially free of analyses of user data.

The computer-implemented transaction method in particular can be implemented as a reward transaction method, like a transaction method for bonus points within a bonus point system and/or as a cryptocurrency transaction method. An online service is in particular to be understood as an offer or service that can be used via the Internet. A provider of the online service may in particular provide a necessary server-side infrastructure. A user of the online service preferably uses a corresponding client (a network-compatible device or software) through which a content that is available via the online service is output. Many online services are implemented as web applications, i.e., they can be used via a web browser and/or a smartphone-/tablet-app. The online service in particular could be implemented as an e-mail distribution list, a newsletter, a blog, an internet forum, a feed reader, an IP telephony/video chat, a groupware, a customer-relationship management platform, a filehosting platform, an internet television, an internet radio, a music streaming platform, an online banking application, an online shopping platform, a computer game, an online learning community, a virtual space environment, etc. however preferably, the online service is implemented as a social network, a video-on-demand platform, an image board, a knowledge database like a wiki/an online encyclopedia or a chat/instant messaging platform.

A creator, in particular a content creator, is a user of the online service who creates content within the online service and/or who provides and/or uploads content to the online service. The content can be original content or a, preferably authorized, copy of already existing content. In particular, the online service receives the content from the creator by upload or by a direct creation within an authoring environment of the online service. In particular, the creator is registered at the online service with a user address, in particular the creator address. Preferably the creator, in particular the user of the online service who is acting as a creator, is registered at the online services with a digital identity like the IOTA™ Unified Identity Protocol or similar. Preferably, the creator address is or at least comprises a crypto address of the creator, in particular the user of the online service who is acting as a creator. In particular, a crypto address is a string of characters that represents a wallet, in particular belonging to a user of the online service, that can send and receive cryptocurrency. Preferably, the crypto address of the crypto wallet of the creator, in particular of the user of the online service who is acting as a creator, is implemented as a reusable crypto address, preferably a reusable crypto address of an IOTA™ wallet. By employing reusable crypto addresses, it advantageously becomes possible that a creator can provide the same crypto address to all potential consumers. Content, which is uploaded to the online service or which is created within the online service is offered for downloading and/or for viewing (and/or listening) within the online service, in particular within a consumer and/or (end-)user environment of the online service. The access to the content via the online service and/or the consumer and/or (end-) user environment of the online service can be fully/unrestricted public or at least partly restricted to only a selected public, which for example could be only registered users of the online service, only users with a registered online (crypto) wallet, only users which have a specific status within the online service, only users which have a specific relation to the creator within the online service, only users from a specific region, of a specific age, etc. Preferably, consuming the content within the online service is free of charge and a rewarding or remuneration is optional/voluntary.

In particular, the user/consumer is registered at the online service with a user address, in particular the consumer address. Preferably the consumer, in particular of the user of the online service who is acting as a consumer, is registered at the online services with a digital identity like the IOTA™ Unified Identity Protocol or similar. Preferably, the consumer address is or at least comprises a crypto address of the consumer, in particular the user of the online service who is acting as a consumer. Preferably, the crypto address of the crypto wallet of the consumer, in particular of the user of the online service who is acting as a consumer, is implemented as a reusable crypto address, preferably a reusable crypto address of an IOTA™ wallet. Preferably, at least one reusable crypto address is attributed to each user of the online service. Of course, a creator can at the same time also be a consumer within the online service and vice versa. The content may be offered by the online service in form of a thumbnail or a descriptive text, wherein selecting the thumbnail or descriptive text will direct the user to a viewing/playback environment of the online service, which allows a full examination of the content by the user.

The step of displaying and/or transmitting the content in particular includes at least a caching of the content in a RAM module of a user device/a consumer device, preferably it includes a streaming of images, videos and/or sounds. The online service sends the content to the user device/consumer device, which for example is embodied as a smartphone or as a personal computer, via a cable-bound or at least partially wireless network connection. By receiving content from the online service and by viewing/listening to the content, the user becomes a consumer of the online service.

The computer-based and/or sensor-based registration of the user response to the content preferably is performed by the user device/the consumer device and/or by an external device, which is in a communication with the user device/the consumer device and/or the online service. In particular, the user device/the consumer device and/or the external device comprises a sensor unit. The sensor unit preferably comprises an optical sensor system, like a CCD-camera and/or an acoustic sensor system, like a microphone, each of which preferably communicates its recordings to an internal or external (for example cloud-based) sensor data processing system. The sensor unit, in particular in combination with the sensor data processing system, is preferably configured to detect an image (for example of the user), a sound (for example of the user), a biometric feature of the user (for example a heart rate, a blush, a pale, a blood pressure, etc.), an action of the user within the software of the online service, like an activation of a button or of another touch-sensitive element of the user device/the consumer device and/or the online service. In particular, in case of an image detection or a sound detection, a facial recognition, an emotion recognition and/or a gesture recognition or in case of a sound recognition, a speech or language recognition and/or a voice recognition is performed during the computer-based and/or sensor-based registration. The response/s of the user that is/are detected and registered by the sensor unit could be a conscious response/s or an unconscious response/s of the user to the retrieved content. It is conceivable that after the user finished consuming the content, the user device/the consumer device presents a summary/report of the registered responses to the user (for example: 5 laughs, 7 grins, 2 frowns, 1 nod, 0 head shakes, 60% of the total view time actively following, 40% of the total view time distracted). This report may assist the user in deciding if a compensation of the creator is appropriate and how high a reasonable compensation would be.

The direct digital financial transaction could in particular be triggered fully automatically without a separate release of the user or upon a confirmation by the user (“Do you really want to transfer the amount of X to user Y? Yes/No”). It is conceivable that a limit exists, wherein all amounts below the limit are triggered fully automatically and all amounts above the limit require a user confirmation. Preferably, this limit is settable by the user/the consumer. A “direct financial transaction” should in particular be understood as a (monetary) transaction wherein the funds are transferred directly between the two transaction partners. Preferably, the direct financial transaction is free of any type of middleman or intermediary, like a banking institution, a payment service provider, etc. Preferably, the direct financial transaction takes place directly between the crypto address (wallet) of the user/the consumer and the crypto address (wallet) of the creator. It is conceivable that every time a computer-based and/or sensor-based response of the user to the content is registered, a separate direct digital financial transaction takes place and/or that only after the consumption of the content is completed a summarized direct digital financial transaction takes place. It is also conceivable that depending on the type of reaction, the direct digital financial transaction takes place immediately (for example when the user activates a “Like”-button) or in a summarized fashion (for example when gestures and emotions are recorded). It is to be mentioned, that the direct digital financial transaction in principle could also go the other way: from the creator to the user/consumer. For example, a company could upload an image clip or an ad or a government institution could upload an information campaign video or a survey and transfer cryptocurrency or similar to everybody that has watched the content.

It is further proposed that in the direct digital financial transaction an exchange of cryptocurrency between the user and the creator is executed. Thereby advantageously a direct, decentralized and near real-time financial transaction can be achieved. In addition, the transaction method advantageously is independent of locations of the users, residencies of the users, exchange course of the local state currency of the users, etc. Advantageously, the transaction method is fully independent from official government-controlled fiat currencies/fiat money based systems. The term “cryptocurrency” is in particular also to be understood as cryptomoney. A cryptocurrency in particular is a digital asset designed to work as a medium of exchange wherein individual coin ownership records are stored in a ledger existing in a form of computerized database using strong cryptography to secure transaction records, to control the creation of additional coins and/or to verify the transfer of coin ownership. The cryptocurrency typically does not exist in physical form (like paper money) and is typically not issued by a central authority.

Cryptocurrencies typically use decentralized control as opposed to centralized digital currency and central banking systems. When implemented with decentralized control, cryptocurrency typically works through distributed ledger technology, like a blockchain or similar, that serves as a public financial transaction database.

In addition, it is proposed that in the direct digital financial transaction, an exchange (one-way or two-way transfer) of a cryptocurrency that at least for machine-to-machine transactions is free of transaction costs, preferably that is completely free of transaction costs, is carried out. Thus, it advantageously becomes possible to transfer very small amounts of funds. In particular, in the direct digital financial transaction an exchange (one-way or two-way transfer) of a transaction-cost-free cryptocurrency is performed. In particular, in the direct digital financial transaction a transaction-cost-free exchange (one-way or two-way transfer) of a cryptocurrency is performed. One example of a transaction-cost-free cryptocurrency is IOTA™.

Moreover, it is proposed that in the direct digital financial transaction, an exchange (one-way or two-way transfer) of a cryptocurrency, which is essentially free from a significant and/or theoretical transaction throughput limitation, is carried out. Thus, a high scalability is achieved, which advantageously makes a very large number of simultaneous transactions possible. For example, on the microblogging platform Twitter alone more than 500 million likes are given daily. If only a fraction of these likes is accompanied by a financial transaction in the future, this will generate a high number of transactions, which exceed the capacities of the known banking system with standard currencies and some crypto currencies with low scalability. A cryptocurrency preferably is to be understood as being “essentially free from a transaction throughput limitation” if at least the transaction throughput of the cryptocurrency is not theoretically limited, e.g. by an average block creation time or similar. In particular, in the direct digital financial transaction an exchange (one-way or two-way transfer) of an at least theoretically transaction-throughput-limitation-free cryptocurrency is performed. In particular, in the direct digital financial transaction of an at least theoretically transaction-throughput-limitation-free exchange (one-way or two-way transfer) of a cryptocurrency is performed. One example of an at least theoretically transaction-throughput-limitation-free cryptocurrency is IOTA™.

It is further proposed that the cryptocurrency is implemented as a distributed ledger technology (DLT)-based cryptocurrency, for example an IOTA™ communication protocol-based cryptocurrency (IOTA™). Thereby a high number of transaction-cost free simultaneous transactions can advantageously be made possible. A “DLT-based” technology/cryptocurrency shall in particular be understood to mean a DLT technology/cryptocurrency with a directed acyclic graphs (DAG) architecture, preferably with a transaction-based directed acyclic graphs (DAG) architecture.

Furthermore, it is proposed that in the direct digital financial transaction an (one way or two way) exchange of cryptocurrency takes place, the equivalent value of which in a fiat reserve currency (e.g. $, €, £, ¥ or CN¥), corresponds to a fraction of a smallest monetary unit of the fiat reserve currency (picopayment/nanopayment), for example less than 0.01 €, less than 0.01 $, less than 0.01 £, etc. Thus, advantageously transactions that equal picopayments/nanopayments are possible. Advantageously, a high user-friendliness and user acceptance can be achieved. Advantageously, very precise and very low payments, which in particular are not possible with standard currency/fiat reserve currency can be made possible. Advantageously, the power of the many can be used to adequately fund content creators.

In addition, it is proposed that the direct digital financial transaction is executed in real time or near real time. Thus, a high efficiency and/or user friendliness can be achieved. The term “near real time” should in particular be understood as within at most ten seconds, preferably within at most one second, more preferably within at most a tenth of a second and most preferably within at most ten milliseconds.

It is further proposed that the direct digital financial transaction is triggered by a computer-based and/or sensor-based registration of a commenting of the content by the user, of a linking of the content by the user and/or of a sharing of the content by the user. Thereby a direct, fast and transparent rewarding of quality content can advantageously be achieved. Thus, the need for ads or data analyses within the online service can advantageously be reduced and an incentive for producing high quality content can be stimulated. Consequently, a user satisfaction of an online service can advantageously be increased. A commenting of a content in particular comprises the step of responding to the content in text form. A liking of a content in particular comprises the step of clicking a button on the Internet to give a positive rating for a content. A sharing of a content in particular comprises the step of letting other people see something that someone else has put on the online service.

If in addition or alternatively the direct digital financial transaction is triggered by a computer-based and/or sensor-based detection of an emotion and/or a gesture of the user, e.g., by a computer-based and/or sensor-based detection of a laugh or an approval sound/gesture from the user, a quality-based reward system or remuneration system is advantageously made possible. Consequently, a content quality of an online service can advantageously be improved and/or a user satisfaction with an online service can advantageously be increased. The range of detectable emotions preferably includes amongst others at least some of the following emotions: laughter, joy, anger, confusion, consent, dissent, attention, distractedness, fear, disgust, shame, sadness and/or surprise. The sensor unit preferably is equipped with the optical sensor system/an optical sensing device that is configured to distinguish at least two, preferably at least three and more preferably at least five different emotions. The range of detectable gestures preferably includes amongst others at least some of the following gesture types: hand gestures, finger gestures, face or eye gestures (e.g. grimaces, winking, etc.), head gestures (e.g. nodding, head shaking, etc.), arm or shoulder gestures (e.g. shrugging, ducking, etc.). The sensor unit preferably is equipped with the optical sensor system/an optical sensing device that is configured to distinguish at least two, preferably at least three and more preferably at least five different gestures and/or gesture types.

In this context, it is further suggested that the computer-based and/or sensor-based detection of an emotion and/or a gesture of the user is correlated to the concurrently consumed content in order to determine whether the emotion and/or gesture was triggered by the content and, depending on this, the direct digital financial transaction is triggered. Thus, a quality-based reward system or remuneration system is advantageously made possible. Consequently, a content quality of an online service can advantageously be improved and/or a user satisfaction with an online service can advantageously be increased. As an example, a consumer watches a video clip and (depending on the type of video) every time the consumer laughs, smiles, reacts surprised or shocked or nods his head in agreement, a direct digital financial transaction is triggered. Hence, after having watched the video clip, the consumer only transfers a reward to the content creator if he enjoyed the video clip (if it for example was a comedy clip) or if he found good advice in the video clip (if it for example was an instructional or educational clip) or if he had a good scare (if it was a horror clip).

If in addition, before the execution of the direct digital financial transaction that is triggered by the computer-based and/or sensor-based detection of emotions and/or gestures of the user, a transaction confirmation is requested from the user, a high level of control in the side of the user can be achieved. Such a transaction confirmation could be requested before each transaction or only after a content consumption is completed. The transaction confirmation could be implemented as a pop-up query within the online service.

Furthermore, it is proposed that the content is a digital media content (e.g. text, image, video, sound, etc.). Thus, a user friendliness and/or a content quality of online services comprising digital media content can advantageously be improved.

In addition, it is proposed that the online service is a social networking service. Thus, a user friendliness and/or a content quality of social media networks can advantageously be improved. Advantageously, the number of advertisements within social media networks can be reduced. Advantageously, the amount of personal data collection within social media networks can be reduced. An operator of the online service would be able to fork off a portion of the revenues particularly easily in order to be able to operate the platform economically. In particular, a social networking service (also social networking site or social media) is implemented as an online platform which people use to build social networks or social relationships with other people who share similar personal or career interests, activities, backgrounds or real-life connections. Examples of existing social networking services are Facebook™, Pinterest™, Reddit™ or Linkedin™.

Additionally or alternatively, it is proposed that the online service is a media database and/or a knowledge database, in particular a Wikipedia-style knowledge database. Advantageously, the number of advertisements or donation requests within media databases and/or knowledge databases can be reduced.

Advantageously, the content quality of media databases and/or knowledge databases can be increased, in particular since additional incentives for authors or content creators to produce qualitatively high articles (knowledge articles) can be achieved. The computer-implemented transaction method according to this invention could advantageously be used to support and/or conduct global fundraising campaigns such as those regularly held to fund Wikipedia. The fundraising campaign would advantageously be programmable in amount by the online service's operator, as the amount of a tax-free donation in a specific country may be limited, so that no tax liability arises on the sender or recipient side.

Additionally or alternatively, it is proposed that the online service is an (instant) messaging service. Thus, a user friendliness and/or a content quality of (instant) messaging services can advantageously be improved. Advantageously, the number of advertisements within (instant) messaging services can be reduced.

Advantageously, the amount of personal data collection within (instant) messaging services can be reduced. An operator of the online service would be able to fork off a portion of the revenues particularly easily in order to be able to operate the platform economically. Examples of existing (instant) messaging services are WhatsApp™, WeChat™, Snapchat™ or Skype™.

Moreover a network-compatible device, in particular a smartphone or a personal computer, which is configured at least for carrying out the computer-implemented transaction method, comprising a processor and a memory and a computer functionality enabling access to an online service, in particular comprising an application software (app) having the online service that is installed on the memory and executable by the processor is proposed. Thus, advantageous characteristics regarding the accessibility and/or distribution of digital content can advantageously be achieved. Furthermore, an improved usability of content-providing online services can advantageously be achieved. A “network-compatible device” is to be understood in particular as a device that can be networked with other devices communicatively.

Preferably, the network-capable device is an Internet-capable device and/or designed as a device connected and/or connectable to the Internet. The term “configured” shall be understood in particular as specially programmed, specially designed and/or specially equipped. By the fact that an object is configured to perform a specific function, it shall be understood in particular that the object fulfills and/or executes this specific function in at least one application and/or operating state.

The computer-implemented transaction method according to the invention and the network-compatible device according to the invention are herein not to be restricted to the applications and implementation forms described above or pictured below. In particular, to fulfill a functionality herein described, the computer-implemented transaction method according to the invention and the network-compatible device according to the invention may comprise a number of respective elements and/or structural components and/or units and/or method steps that differ/s from a number herein mentioned. The features that are described in the dependent claims are combinable at will, as long as this does not result in any contradictions.

### DRAWINGS

Further advantages will become apparent from the following description of the drawings. In the drawings, three exemplary embodiments of the invention are depicted. The drawings, the description and the claims contain a plurality of features in combination. Someone skilled in the art will purposefully also consider the features separately and will find further expedient combinations.

It is shown in:

FIG. 1: a schematic depiction of a network-compatible device,

FIG. 2: a schematic flow diagram of a computer-implemented transaction method for online services, using the network-compatible device,

FIG. 3a: an exemplary view of a graphical user interface of the online service during a method step of the computer-implemented transaction method,

FIG. 3b: a second exemplary view of the online service's graphical user interface during a further method step of the computer-implemented transaction method and

FIG. 3c: a third exemplary view of the online service's graphical user interface during another further method step of the computer-implemented transaction method.

### DESCRIPTION OF THE EXEMPLARY EMBODIMENT

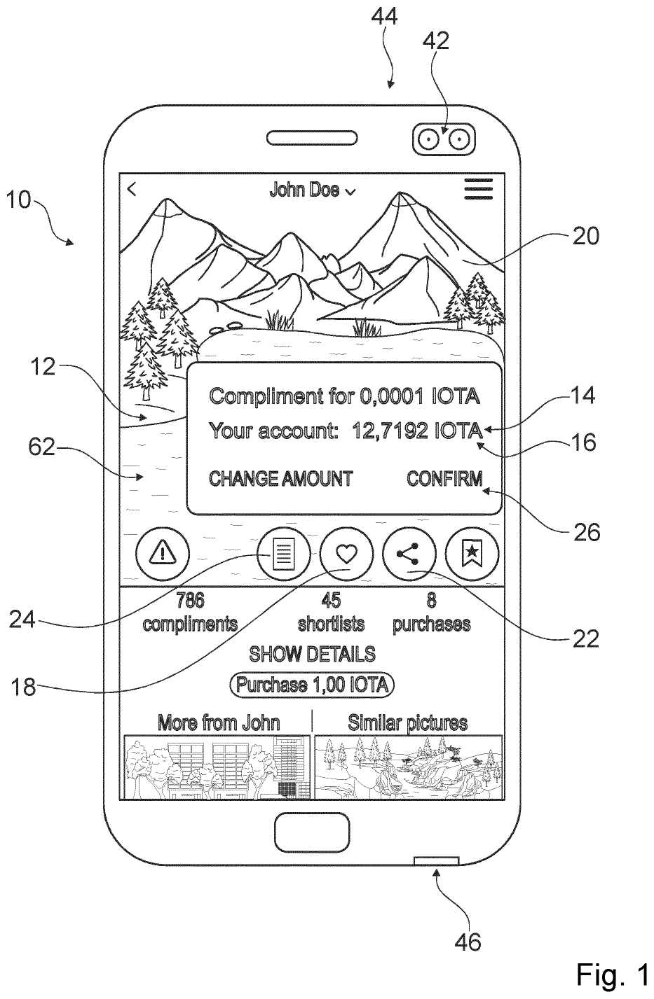

The FIG. 1 shows schematically a network-compatible device 10. The network-compatible device 10 exemplary is implemented as a smartphone. The network-compatible device 10 is configured for carrying out a computer-implemented transaction method as it is described herein. The network-compatible device 10 comprises a processor (not shown) and a memory (not shown). The network-compatible device 10 comprises a computer functionality enabling access to an online service 12. The online service 12 exemplary is implemented as a social networking service that comprises image sharing functionality. Alternatively or additionally, the online service 12 could also be implemented as a media database, as a knowledge database or as an (instant) messaging service, etc. In the exemplary case of a social networking service with an image sharing functionality, shared images constitute a content 20 of the online service 12. Alternatively or additionally, the content 20 could also be another digital media content, like a text, a video, a sound, etc. An application software having the online service 12 is (pre-)installed on the memory of the network-compatible device 10 and executable by the processor of the network-compatible device 10. The online service 12 requires a user registration. Every user account that is registered within the online service 12 can be linked with a crypto address. The crypto address represents a payment address for a crypto wallet 14. The crypto address is reusable. The crypto wallet 14 can be filled up with a cryptocurrency 16. In the example of FIG. 1 the crypto wallet 14 uses IOTA or MIOTA (million IOTA or Mega-IOTA). The online service 12 comprises a like button 18. The like button 18 enables a liking/complimenting of content 20 within the online service 12. The online service 12 comprises a share button 22. The share button 22 enables a sharing of content 20 within the online service 12 or external to the online service 12. The online service 12 comprises a comment button 24. The comment button 24 enables a commenting of content 20 within the online service 12. The FIG. 1 exemplary shows a transaction confirmation query 26. The transaction confirmation query 26 can optionally be displayed before a direct digital financial transaction upon a liking, a sharing or a commenting, etc. of the content 20 takes place. Furthermore, the exemplary online service 12 includes a purchase function, which allows a purchasing of rights to use for certain content 20 (images) of the online service 12. The network-compatible device 10 comprises a sensor unit 44. The sensor unit 44 is configured to at least optically and/or acoustically observe a user of the network-compatible device 10. The network-compatible device 10 comprises a camera 42. The sensor unit 44 comprises an optical sensor system. The sensor unit 44 comprises the camera 42. The camera 42 forms at least part of the optical sensor system of the sensor unit 44. The network-compatible device 10 comprises a microphone 46. The sensor unit 44 comprises an acoustic sensor system. The sensor unit 44 comprises the microphone 46. The microphone 46 forms at least part of the acoustic sensor system of the sensor unit 44.

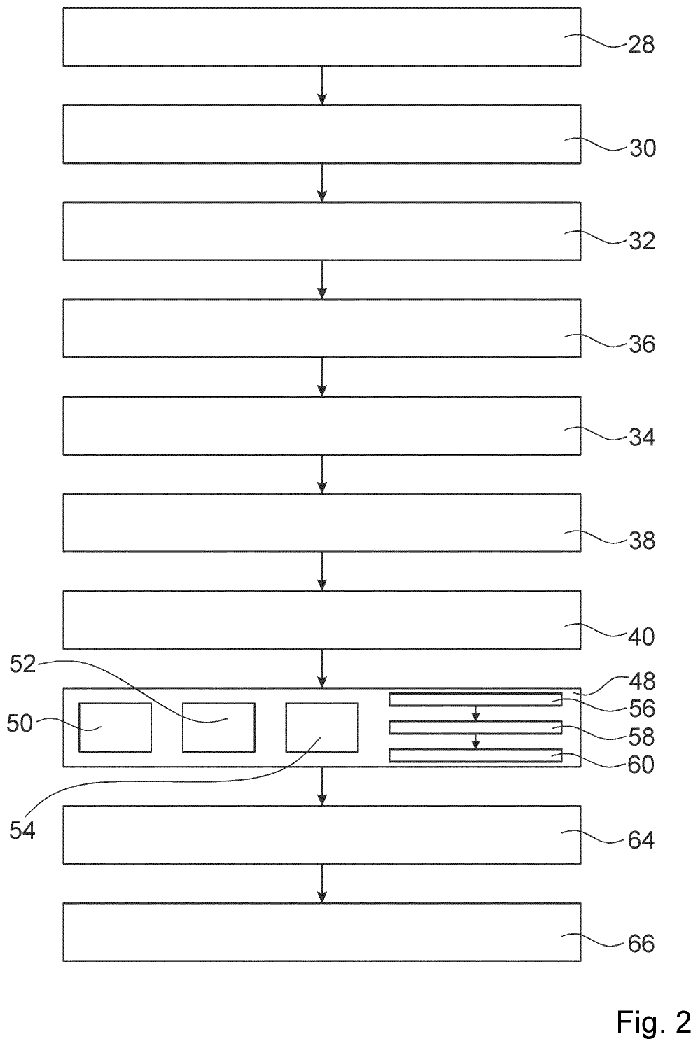

The FIG. 2 shows a schematic flow diagram of the computer-implemented transaction method for the online service 12. In at least one method step 28 a user of the online service 12 acts as a creator and uploads content 20, for example an image, to the online service 12. In at least one further method step 30, the online service 12 receives the content 20 that is provided by a creator. In at least one further method step 32, the content 20 is saved by the online service 12. In at least one further method step 36, the content is linked by the online service 12 to a creator address. The creator address is a (reusable) crypto address/crypto wallet 14 of the user who acted as content creator. In at least one further method step 34, the content 20 is offered by the online service 12 ready for retrieval. In the method step 34 the content 20 is offered for viewing and/or for downloading. In the method step 34 the content 20 is offered at least partially publicly. In the method step 34 the content 20 is offered to other users of the online service 12. In the method step 34 the content 20 is offered free of charge. In at least one further method step 38, the online service 12 displays and/or transmits the content 20 to a user of the online service 12 who acts as a consumer. The user of the online service 12 who acts as a consumer is assigned a consumer address within the online service 12. The consumer address is a (reusable) crypto address/crypto wallet 14 of the user who acted as content consumer. In the method step 38, the user of the online service 12 who acts as a consumer consumes the content 20 (for example views the image).

In at least one further method step 40, a response of the consuming user to the retrieved content 20 is registered by the network-compatible device 10 that belongs to the consuming user or by an external device that preferably is in communication with the network-compatible device 10 of the consuming user. The response of the consuming user to the retrieved content 20 is registered by at least one sensor 42, 46 of the sensor unit 44 of the network-compatible device 10. In the method step 40, the sensor unit 44 performs a computer-based registration of the response of the user to the retrieved content 20. The computer-based registration is configured to register any interaction of the user with the online service 12, for example an activation of any of its buttons 18, 22, 24, and/or to processes information about the user that is gathered by the sensor unit 44. In the method step 40, the sensor unit 44 performs a sensor-based registration of the response of the user to the retrieved content 20. The sensor-based registration is configured to register any interaction of the user with the online service 12, for example an activation of any of its buttons 18, 22, 24, and/or to register gestures of the user, emotions of the user, speech of the user, etc.

In at least one further method step 48, a direct digital financial transaction between the user and the creator, preferably between the consumer address and the creator address, is triggered. The direct digital financial transaction between the user and the creator of the method step 48 is performed free of any intermediary or middleman. In the method step 48, the direct digital financial transaction between the user and the creator is triggered as a consequence of the computer-based and/or the sensor-based registered response of the user to the retrieved content 20. In the direct digital financial transaction of the method step 48, an exchange of cryptocurrency 16 between the user and the creator is executed. In the direct digital financial transaction of the method step 48, an exchange of a cryptocurrency 16 that at least for machine-to-machine transactions is free of transaction costs, preferably that is completely free of transaction costs, is carried out. In the direct digital financial transaction of the method step 48, an exchange of a cryptocurrency 16, which is essentially free from a transaction throughput limitation, is carried out. The cryptocurrency 16 that is exchanged in the method step 48 is implemented as a distributed ledger technology (DLT)-based cryptocurrency 16. The cryptocurrency 16 that is exchanged in the method step 48 is implemented as an IOTA™ communication protocol-based cryptocurrency 16. In the direct digital financial transaction of the method step 48, an exchange of cryptocurrency 16 takes place, the equivalent value of which in a fiat reserve currency (e.g. $, €, £, ¥ or CN¥), corresponds to a fraction of a smallest monetary unit of the fiat reserve currency, i.e. for example a fraction of 1 Dollar Cent or a fraction of 1 Euro Cent. In the direct digital financial transaction of the method step 48 a picopayment and/or a nanopayment is performed. The direct digital financial transaction of the method step 48 is executed in real time or in near real time.

In at least one optional method sub-step 50 of the method step 48, the direct digital financial transaction is triggered by a computer-based and/or sensor-based registration of a commenting of the content 20 by the consuming user. In the method sub-step 50, the sensor unit 44 of the network-compatible device 10 registers a pressing of the comment button 24 of the online service 12. In at least one further optional method sub-step 52 of the method step 48, the direct digital financial transaction is triggered by a computer-based and/or sensor-based registration of a liking of the content 20 by the consuming user. In the method sub-step 52, the sensor unit 44 of the network-compatible device 10 registers a pressing of the like button 18 of the online service 12. In at least one further optional method sub-step 54 of the method step 48, the direct digital financial transaction is triggered by a computer-based and/or sensor-based registration of a sharing of the content 20 by the consuming user. In the method sub-step 54, the sensor unit 44 of the network-compatible device 10 registers a pressing of the share button 22 of the online service 12.

In at least one further optional method sub-step 56 of the method step 48, the direct digital financial transaction is triggered by a computer-based and/or sensor-based detection of an emotion and/or a gesture of the user, e.g., by a computer-based and/or sensor-based detection of a laugh or an approval sound/gesture from the user. In the method sub-step 56, the sensor unit 44 of the network-compatible device 10 optically and/or acoustically registers the consuming users actions/reactions. In at least one further method sub-step 58 (following the method sub step 56), the computer-based and/or sensor-based detection of an emotion and/or a gesture of the consuming user is correlated to the content 20 that is consumed by the user concurrently with the detection of the action/the reaction of the user. The correlation between the action of the user and the consumed content 20 is used in the method sub-step 58 in order to determine whether the registered emotion and/or the registered gesture was triggered by the content 20 and, depending on this, the direct digital financial transaction of the method step 48 is triggered. In at least one further optional method sub-step 60, a transaction confirmation, for example in the form of an acknowledgement of the transaction confirmation query 26, is requested from the user before the execution of the direct digital financial transaction that was triggered by the computer-based and/or sensor-based detection of emotions and/or gestures of the user in the method sub-step 56. Of course, the transaction confirmation query 26 alternatively or additionally can also be prompted before the execution of the direct digital financial transaction that was triggered by the pressing of any of the online service's 12 buttons 18, 22, 24. In at least one further method step 64, the consuming user confirms the transaction confirmation query 26 and the direct digital financial transaction is performed. In at least one further method step 66 a confirmation of the direct digital financial transaction is displayed by the online service 12.

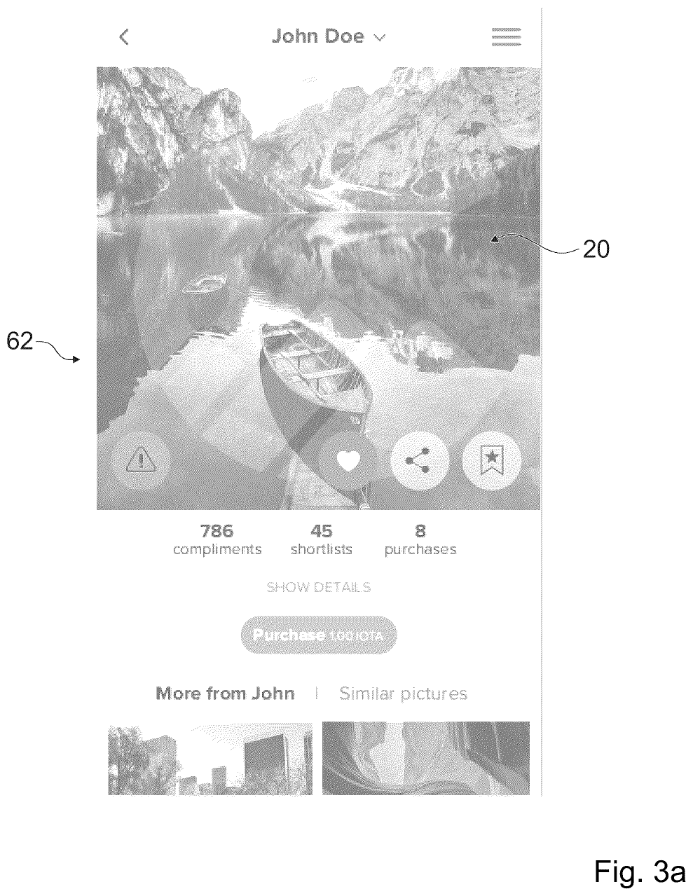

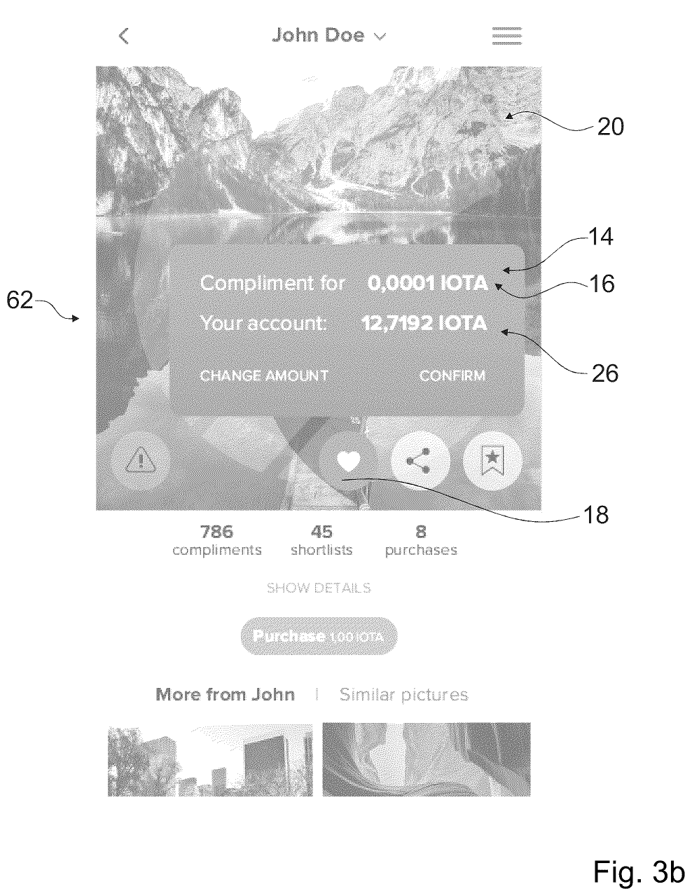

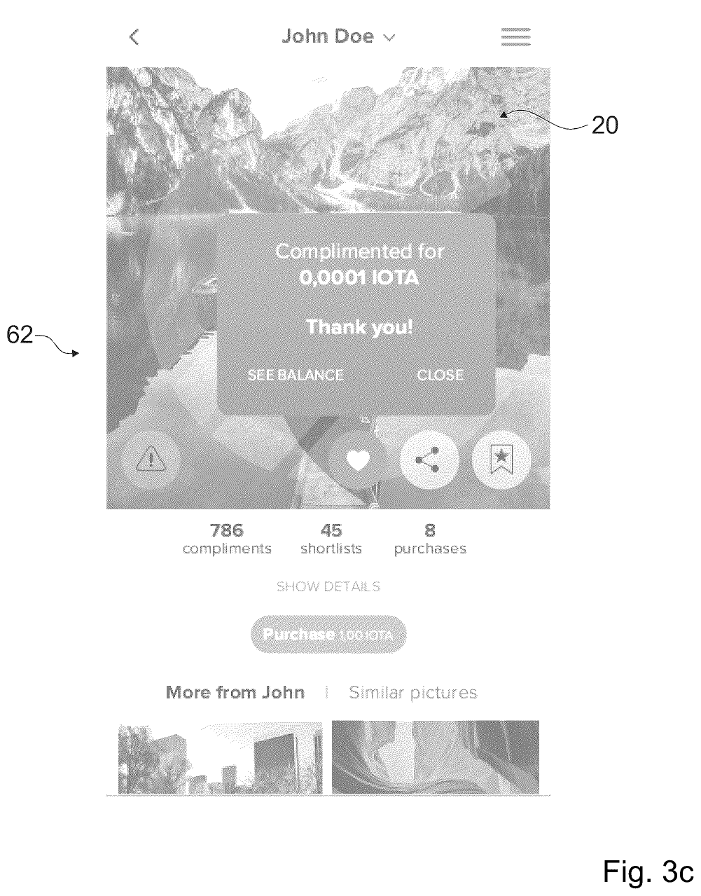

The FIGS. 3a, 3b and 3c show the online service's 12 graphical user interface (GUI) 62 during different exemplary steps of the computer-implemented transaction method. FIG. 3a shows the GUI 62 of the online service 12 during the method step 38, in which the consuming user consumes the content 20, i.e., in this case an image of a mountain lake with unoccupied rowboats. FIG. 3b shows the GUI 62 of the online service 12 during the method sub-step 60 and after a pressing of the like button 18 by the user triggered the direct digital financial transaction and wherein the transaction confirmation query 26 was prompted as a result before the IOTA cryptocurrency is transferred between the consumer address and the creator address. FIG. 3b shows the GUI 62 of the online service 12 during the method step 66, displaying a confirmation of the direct digital financial transaction and a current crypto balance of the crypto wallet 14 after the transaction.

1. A computer-implemented transaction method for online services, comprising at least the steps of
receiving a content provided by a creator by an online service,
offering the content by the online service ready for retrieval, in particular at least partially publicly, preferably free of charge, wherein preferably the content is linked by the online service to a creator address,
displaying and/or transmitting the content by the online service to a user of the online service, wherein a consumer address is preferably assigned to the user within the online service,
computer-based and/or sensor-based registration of a response of the user to the retrieved content, and
triggering a direct digital financial transaction between the user and the creator, preferably between the consumer address and the creator address, as a consequence of the computer-based and/or sensor-based registered response of the user to the retrieved content.

2. The computer-implemented transaction method according to claim 1, wherein in the direct digital financial transaction an exchange of cryptocurrency between the user and the creator is executed.

3. The computer-implemented transaction method according to claim 2, wherein in the direct digital financial transaction, an exchange of a cryptocurrency that at least for machine-to-machine transactions is free of transaction costs, preferably that is completely free of transaction costs, is carried out.

4. The computer-implemented transaction method according to claim 2, wherein in the direct digital financial transaction, an exchange of a cryptocurrency, which is essentially free from a transaction throughput limitation, is carried out.

5. The computer-implemented transaction method according to claim 2, wherein the cryptocurrency is implemented as a distributed ledger technology (DLT)-based cryptocurrency, for example an IOTA™ communication protocol-based cryptocurrency (IOTA™).

6. The computer-implemented transaction method according to claim 1, wherein in the direct digital financial transaction an exchange of cryptocurrency takes place, the equivalent value of which in a fiat reserve currency (e.g. $, €, £, ¥ or CN¥), corresponds to a fraction of a smallest monetary unit of the fiat reserve currency (picopayment/nanopayment).

7. The computer-implemented transaction method according to claim 1, wherein the direct digital financial transaction is executed in real time or near real time.

8. The computer-implemented transaction method according to claim 1, wherein the direct digital financial transaction is triggered by a computer-based and/or sensor-based registration of a commenting of the content by the user.

9. The computer-implemented transaction method according to claim 1, wherein the direct digital financial transaction is triggered by a computer-based and/or sensor-based registration of a liking of the content by the user.

10. The computer-implemented transaction method according to claim 1, wherein the direct digital financial transaction is triggered by a computer-based and/or sensor-based registration of a sharing of the content by the user.

11. The computer-implemented transaction method according to claim 1, wherein the direct digital financial transaction is triggered by a computer-based and/or sensor-based detection of an emotion and/or a gesture of the user, e.g., by a computer-based and/or sensor-based detection of a laugh or an approval sound/gesture from the user.

12. The computer-implemented transaction method according to claim 11, wherein the computer-based and/or sensor-based detection of an emotion and/or a gesture of the user is correlated to the concurrently consumed content in order to determine whether the emotion and/or gesture was triggered by the content and, depending on this, the direct digital financial transaction is triggered.

13. The computer-implemented transaction method according to claim 11, wherein before the execution of the direct digital financial transaction that is triggered by the computer-based and/or sensor-based detection of emotions and/or gestures of the user, a transaction confirmation is requested from the user.

14. The computer-implemented transaction method according to claim 1, wherein the content is a digital media content (e.g. text, image, video, sound, etc.).

15. The computer-implemented transaction method according to claim 1, wherein the online service is a social networking service.

16. The computer-implemented transaction method according to claim 1, wherein the online service is a media database and/or a knowledge database.

17. The computer-implemented transaction method according to claim 1, wherein the online service is an (instant) messaging service.

18. A network-compatible device, in particular a smartphone or a personal computer, which is configured at least for carrying out the computer-implemented transaction method according to claim 1, further comprising a processor and a memory and a computer functionality enabling access to an online service, in particular comprising an application software having the online service that is installed on the memory and executable by the processor.
